(19) United States
(12) Patent Application Publication
(10) Pub. No.: US 2003/0144857 A1
(43) Pub. Date: Jul. 31, 2003

(54) Business method for tracking customer presentations by vehicle sales representatives

(76) Inventors: Gerald Lacour, Leander, TX (US); Garrett Lacour, Leander, TX (US); Robert Cobin, Leander, TX (US); Matt Nowicky, Leander, TX (US)

Correspondence Address: DAVID G. HENRY, 7th Floor, 900 Washington Avenue, P.O. Box 1470, Waco, TX, 77603-1470, US

(21) Appl. No.: 10/060,033

(22) Filed: Jan. 28, 2002

(51) Int. Cl. G06F 17/60

(52) U.S. Cl. 705/1; 705/14

(57) ABSTRACT

The invention is of a novel business method for presenting pre-recorded promotional presentations to customers at vehicle dealerships, ordinarily in connection with after-market products or services. The system plays one or more presentations to customers, based on selection criteria entered into an on-screen start menu. After the selected one or more presentations are viewed, a customer (or the sales staff member) is presented with purchasing decision menu. Upon conclusion of the presentation and indicated purchase decision, the software which manages the system records to a searchable database, for each viewing session, at least the particular presentations that were viewed, by whom they were shown, the customer to whom they were shown, the purchasing decision as to each product or service presented.

### BACKGROUND OF THE INVENTION

1. Field of The Invention

The present invention relates to business methods, and business methods in the vehicle sales area in particular.

2. Background Information

While profits of vehicle dealerships are seldom high on the list of most individuals' priorities, a vehicle dealership must be profitable if it is to survive. If it is not profitable, it will go out of business. If this event is repeated across the country, vehicle sales will be hampered, with a ripple effect which will seriously damage the United State's quite vehicle-dependant economy.

The dealership profit realized in many vehicle transactions stems as much from “after-market” sales, as from the actual vehicle sale itself. Sales of extended warranties, after-market alarms, fabric and paint protectors, window etching, up-grade electronics, and even financing-related products (credit life insurance, for example), all can contribute significantly to an automobile dealership's profits.

The aforementioned products and services are not solely profit opportunities for dealerships, but also opportunities for customers to enhance the enjoyment of their new vehicle, increase their personal safety, and/or more effectively manage their finances.

If a vehicle purchaser is never offered, or is ineffectively offered the after-market products and services available from a particular dealership, everyone loses. Nevertheless, this is a frequent problem. Whether because of poor training, personal issues, or apathy, many sales staff members in vehicle dealerships do a poor job, if at all, of presenting aftermarket products or services. Often, if they do present the opportunities, the presentation is of a nature as to repel, not attract sales.

Even if a sales staff member can be motivated to present after-market opportunities to customers, no amount of training or motivation can overcome a given individual's lack of basic talent in effectively presenting certain opportunities to customers, nor worker apathy, when such is an issue. And top talent sales staff are not always available to any given dealership at-will.

In view of the above, it would well serve all involved in the vehicle purchase transaction to have a system or business method available which both optimizes the quality of presentation of after-market product and service opportunities, and provides means by which a dealership can track whether or not such presentation occur in each and every sales transaction.

### SUMMARY OF THE INVENTION

In view of the foregoing, it is an object of the present invention to provide a novel business method which benefits automobile dealers and customers.

It is another object of the present invention to provide a novel business method for conducting vehicle sales transactions that involves utilizing audio visual recordings for after-market product and service presentations.

It is another object of the present invention to provide a novel business method for conducting vehicle sales transactions that involves utilizing audio visual recordings for after-market product and service presentations, the use of which on each occasion generates a later-searchable record which indicates that a presentation was made, and if it was displayed to completion.

In satisfaction of these and related objects, the present invention provides a novel business method and associated apparatus which, through computer-based audio visual technology and database technology presents, upon selection, one or more audio visual presentations in promotion of a particular after-market product or service, and upon each use, records in a searchable database, that which was presented, by whom (which salesperson), to whom (which customer), and what was purchased. Additional data may easily be required for completion of the presentation and later analysis by management, such as, the financing selected by the customer, the type of vehicle purchased, demographic data, day of week, or time of day, and so forth, any one of which data fields may provide useful information for marketing purposes.

The present system and associated method will enable automobile dealerships to track use and effectiveness of after-market presentations as to salespeople, after-market programs, customer categories, etc. Because the audio visual presentations are, in the preferred mode of the invention, professionally “staged” and packaged, complete with professional voice-overs, “virtual actors”, suitable music, etc., all presentations will be standardized and optimal, and, accordingly, not affected by the variations among sales staff members as to personal presentation styles or skills.

### DETAILED DESCRIPTION OF THE PREFERRED EMBODIMENT

Computer-based audio visual presentations are certainly not new, but the combination of their use as to specific afer-market vehicle products and services, combined with a tracking mechanism to insure their use is new and unobvious.

The present system involves an audio visual data file (a file stored on a computer disk which may be “played” through use of well-known multi-media software) which includes a promotional presentation for each after-market product or service which a particular vehicle dealership wishes to offer to its customers.

A software program which coordinates the presentation system (“a promotional presentation management software routine”) presents an on-screen start menu which, through use of clickable soft “buttons” allows the sales staff member to either select the product or service presentation(s) that a customer will be shown, or to select criteria upon which the software will automatically “select” the appropriate presentation or presentations, based on input specifics of a particular transaction or customer. The software can, through ordinary skills of any competent programer, be customized to allow either option, and any number of criteria combinations for tailoring presentations to individual customers. In addition, the menu will call for the sales person's employee ID number (or some other, suitable identifier) and for the customer's name.

Upon completing the initial menu selections, the management software, directly, or by actuating secondary software, plays the appropriate audio visual files. At the end of the presentation, a secondary menu appears, and requires input as to the purchasing decision of the customer. At this point, after the selection is made, the next product or service presentation is shown, again, with a menu or input screen at the conclusion, which requires a “YES” or “NO” type response as to the purchasing decision.

As the after-presentation response is given, the management software records to a searchable database: (1) which particular presentations were shown; (2) if the presentation(s) was/were shown to completion(as indicated by the receipt of a “YES” or “NO” response); if the presentation(s) was/were not viewed to completion (as indicated by the lack of a response after a pre-determined period of time without a response, in which case the system re-sets to the initial menu); (4) what the purchase decision was as to each related product or service; (5) who the sales person was; and (6) any other data by which the dealership wishes to track presentations and sales pertaining to aftermarket products and services.

The above data is recorded in a database (usually in a remote server, if the computer which is utilized is networked), but in any event in a database which is password protected, and can be searched as to any criteria which is recorded for each transaction.

Of course, all menus and software screens can be customized with the user dealership's name and logo, and the product presentations can be customized as to content, groupings, or durations.

Software for managing the presentations and data recordings as described above may be obtained from Innovative Aftermarket Systems, Inc. of Leander, Tex. (assignee of the subject patent application) under the trademark SMARTTRAC.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A business method for managing after-market product and service presentations to vehicle purchase customers comprising the steps of:
selecting a computer system with audio and video presentation means, and with storage media means;
recording a plurality of audio visual promotional presentations onto said storage media means;
selecting and installing an audio visual player software routine onto said storage media means, which audio visual player software routine, upon actuation, plays said audio visual promotional presentations;
selecting and installing a promotional presentation management software routine, which promotional presentation management software routine: (a) presents to a user a start menu into which is entered a user identification and selection data for selecting one or more audio visual promotional presentations which are to be presented to a viewer, (b) based on said selection data selects said one or more promotional presentations and sequentially displays same to a viewer, (c) presents a purchase menu into which a user inputs data reflective of a positive or negative purchasing decision, and (d) records into a searchable database a record indicating said selection data, the identity of said one or more promotional presentations, said user identification, the time and date of said actuating of said software, and said data reflective of said positive or negative purchasing decision;
inputting said user identification and selection data into said start menu of said promotional presentation management software routine and actuating said promotional presentation management software routine for initiating said displaying of said one or more promotional presentations; and
inputting said data reflective of said positive or negative purchasing decision at the end of said displaying of each said one or more promotional presentations.

2. The method of claim 1 further comprising the steps of:
searching said searchable database to compile data reflective of data stored by said promotional presentation management software routine.
